(19) United States
(12) Patent Application Publication
(10) Pub. No.: US 2011/0122120 A1
(43) Pub. Date: May 26, 2011

(54) CONTAINER BEARING AN ELECTONIC LABEL WITH A SCREEN

(75) Inventor: Guy Feuilloley, Octeville Sur Mer (FR)

(73) Assignee: Sidel Participations

(21) Appl. No.: 12/989,321

(22) PCT Filed: Apr. 23, 2009
(86) PCT No.: PCT/FR09/00480

§ 371 Date: Feb. 4, 2011

(30) Foreign Application Priority Data
Apr. 25, 2008 (FR) 08/02341

(51) Int. Cl. G09G 3/34; G09G 5/00

(52) U.S. Cl. 345/211; 345/107

(57) ABSTRACT

Container (1) equipped with a body (2) containing a product, on which is affixed a flexible electronic label (5) adaptable to the contours of the container (1), the label (5) comprising:
an electronic screen (8) for displaying information relating to the product and visible to a user;
a micro-controller (10) linked to the screen (8) for controlling the display of information on said screen and the updating of said information;
a power source (9) linked to the micro-controller;
   wherein the label is affixed to the container (1) by means of a film (20) applied to an exterior side (3) of the container (1).

The invention relates to the labeling of containers such as plastic or glass bottles or metal cans. More precisely, the invention relates to labels legibly displaying information about the product for a customer.

The labels commonly encountered on store shelves consist of a support on which is permanently inscribed various information about the product for the customer such as, for example, the brand name of the product, the name of the company, the expiration date, the price, etc.

Once a product is put on a shelf, it is not uncommon for some of this information (especially the price) to change, thus requiring relabeling. These changes result in additional handling as a result of having to make new labels and paste them over the old labels.

It is therefore of interest to propose a blank label capable of listing the information specific to just the product on which the label is affixed and permitting this information to be updated with the least amount of handling possible.

Additionally, in the case of containers such as bottles, the surface on which is affixed the label (that which is visible to the customer) is generally curved. The label must therefore be sufficiently flexible in order to be able to adapt to this curvature.

The present invention relates to a container bearing an electronic label possessing a thin display screen for the customer, wherein this screen is sufficiently flexible so that the label adapts to the curved surface of the container. The label further comprises means for controlling the display of information, ensuring rapid and expedient updating.

Techniques for making screens as flexible and thin as sheets of paper, which are known as electronic paper (e-paper), are known to the prior art.

U.S. Pat. No. 4,143,103 of the company XEROX describes a method for manufacturing flat panels suitable for displaying information legible for a normal human eye by means of bicolor particles contained in a solid substance and by means of a dielectric liquid absorbed by the solid substance in such a way that the particles are able to pivot under the action of an outside force, but without moving in translation in their medium.

French patent application 2 901 615 of the company PHILIPS proposes a panel containing an electronic ink (e-ink). This ink contains different-colored particles contained in capsules and responding to voltages in ranges of different levels so that by controlling discharges by means of two electrodes, information legible to a human being is displayed.

U.S. Pat. No. 6,664,944 of the company E-INK is based on a means similar to the one disclosed above. On a substrate are disposed capsules containing a fluid and charged particles with optical properties. These particles are colored, black, or white. Two electrodes are placed on each side of the substrate. When a difference in potential is created between the two electrodes, depending on their electrical properties, the particles in each case migrate toward one of the electrodes, thus creating a visual effect.

Electronic labels enabling the displaying and updating of information about a product already exist.

U.S. patent application 2007 0152045 describes a label for electronic components enabling the displayed information to be changed each time the state of the component changes. To this end, the component in question has a memory dedicated to the storage of information about the component. Each time the information changes, an interface inserted in the component reads the information and commands the display of information on a screen to change. The screen is an e-paper screen and ensures the display of information even when the power is cut off. The memory and the interface between this memory and the screen are borne by the component.

European patent 1 240 619 proposes an electronic label comprising a flexible support on which are disposed the constituent elements of the label, an antenna for communicating with a remote reader and for serving as a power source, and an e-chip storing information plus a rigid shielding for the chip.

European patent application 1 645 997 discloses a system for labeling products in a unique manner and comprising an e-paper display means and a memory. It further comprises a means for inputting specific data on the product in the memory. In this manner, the label ensures the follow-up and management of the products during the various transit stages thereof, from the factory where they are made to the warehouses where they are stored to the customer to whom they are delivered, wherein the label changes its display with each change in the status of the products.

In the opinion of the inventors, however, effective electronic labeling on store shelves that is both attractive and sufficiently energy-efficient cannot be achieved with these labels.

In fact, in view of the competition in the large-scale consumer products industry, which manufacturers nowadays need to take into account, what is important is no longer merely providing information about a product, but also drawing the customer's attention to the product. This is why many labels produce visual effects such as creating the illusion of a relief or of a motion.

These labels, however, are limited in terms of their displaying capacity because of their surface, which cannot exceed that of the product on which they are affixed, and in terms of their attractiveness and distinctness owing to the static nature of the display.

The invention aims in particular to remedy these disadvantages.

To this end, the invention relates to a container equipped with a body containing a product, on which is affixed a flexible electronic label adaptable to the contours of the container, the label comprising:
an electronic screen enabling the display of information related to the product and legible to a user;
a microcontroller linked to the screen for controlling the display of information on said screen and the updating of said information;
a power source linked to the microcontroller;
   wherein the label is affixed to the container by means of a film applied on an exterior side of the container.

The electronic screen is, for example, an e-paper screen comprising a substrate on which is disposed a substance such as e-ink. The ink comprises, for example, an organic substance such as light-emitting diodes or liquid crystals.

According to a preferred embodiment, the container comprises a communication interface linked to the microcontroller.

The interface emits and receives, e.g., radio waves or infrared waves.

The power source is advantageously a photovoltaic cell or a battery.

The container can further comprise an energy storage component such as a storage cell or supercapacitor.

Preference is given to the microcontroller regulating the power supplied to the screen.

According to the preferred embodiment, the display on the electronic screen is a residual display.

The film is advantageously a thermo-retractable film.

The label can be affixed on or under all or part of the thermo-retractable film.

The label can advantageously be separated from the thermo-retractable film in order to facilitate recycling.

Other objects and advantages of the invention will emerge more clearly from the following description, which refers to the appended drawings in which:

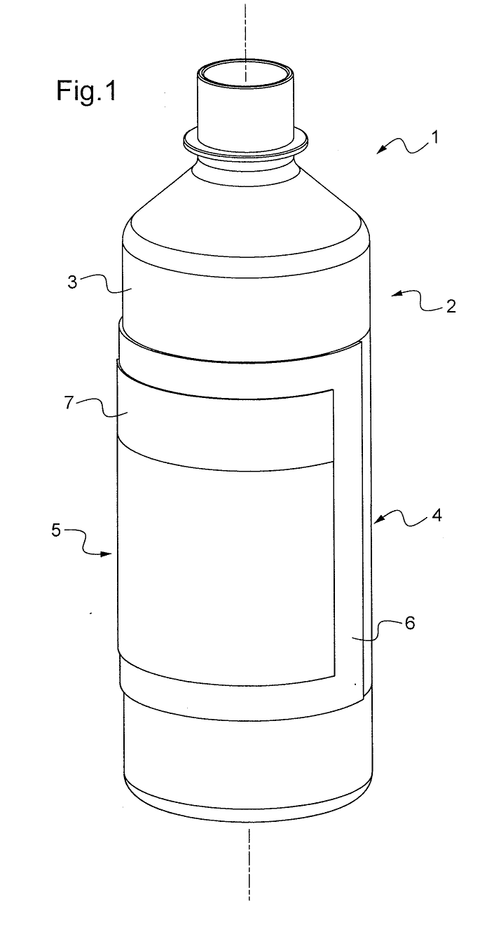

FIG. 1 is a perspective view of a container comprising a label covered with a protective film;

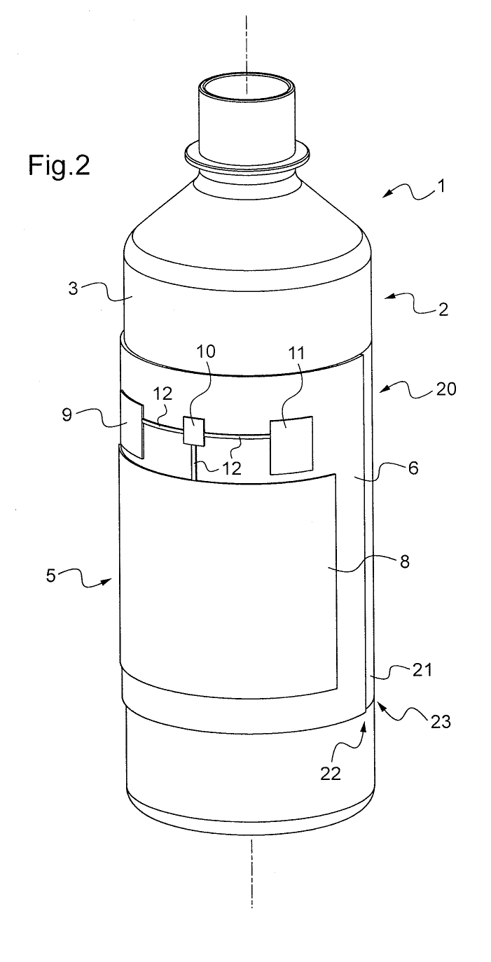

FIG. 2 is a perspective view of the container of FIG. 1 in which the protective film has been removed from the label;

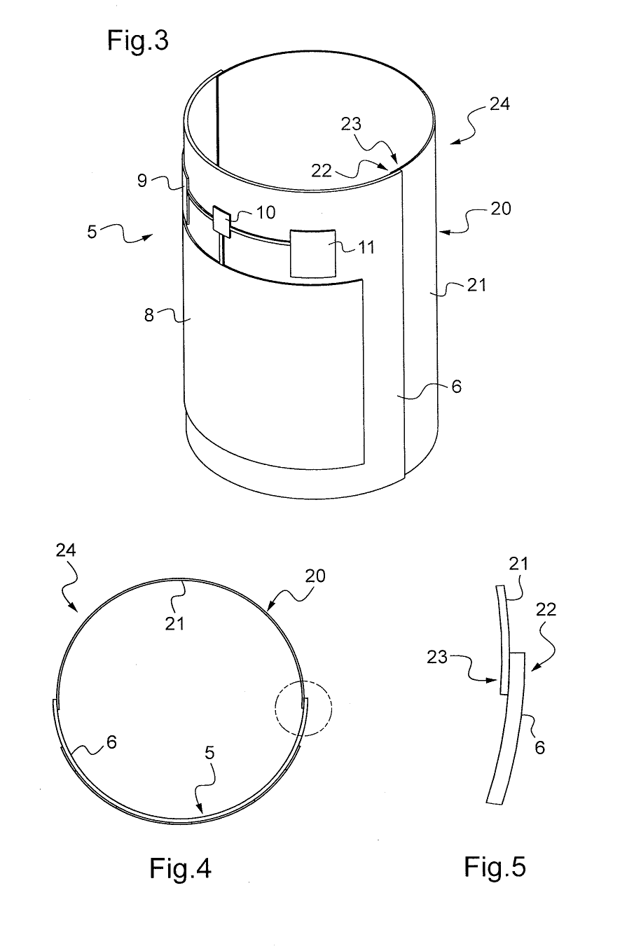

FIG. 3 is a perspective view of the label affixed by both ends on a thermo-retractable film;

FIG. 4 is a view from above of FIG. 3;

FIG. 5 is a detail view of FIG. 4, showing the end of the label affixed to the film;

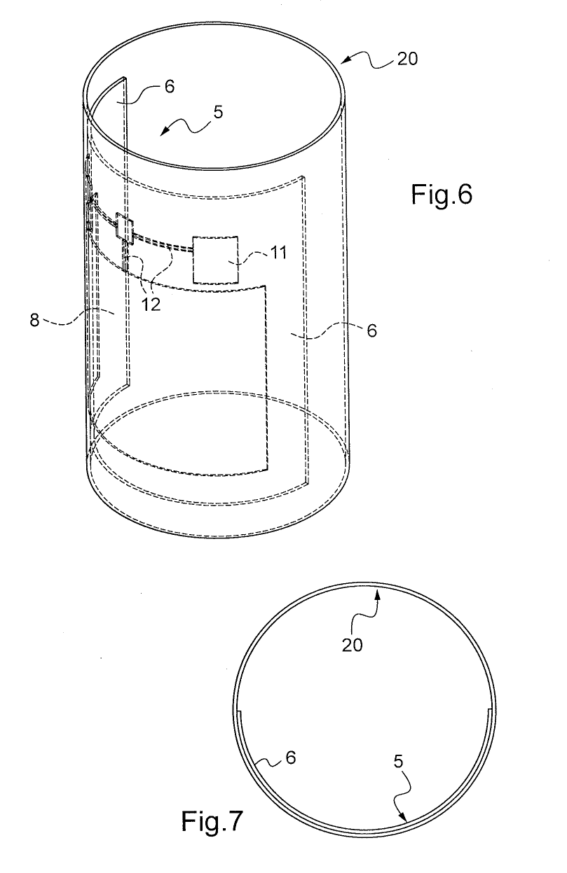

FIG. 6 is a perspective view of the label mounted under a sheath formed in a thermo-retractable film;

FIG. 7 is a view from above of the label of FIG. 6;

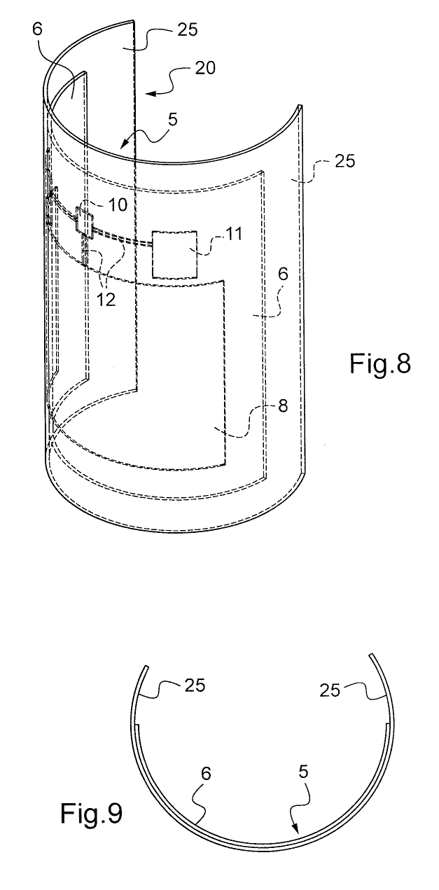

FIG. 8 is a perspective view of the label mounted under a section of a thermo-retractable film sheath;

FIG. 9 is a view from above of the label of FIG. 8.

With reference to FIG. 1, a container 1 designed for sale and therefore for display, e.g., on store shelves is illustrated. It comprises a body 2 with the overall shape of a cylinder. However, the shape of the body 2 is not limiting and can assume any geometric form. The container 1 can be made of any type of material, the most common ones being plastic (e.g., PET), cardboard, glass, or also metal. The body 2 is delimited by an interior surface (not visible in the figures) defining the space in which a product will be stored in the container, and an exterior side 3. In the example illustrated, the exterior side 3 of the body 2 has an appreciably uniform middle region 4, in other words, one with no irregularities as far as a user is concerned.

The container bears a label 5 on its middle region 4. The label 5 has a support 6 consisting of a flexible insulating material.

“Flexible” in this case designates the property of an element that allows it to bend and thus adapt itself to the shape of the surface on which it is affixed, without having to use a tool to shape it and without causing damage to said element.

The label 5 is at least partially covered with a protective film 7, which shall be described in detail later on.

In FIG. 2, the protective film 7 has been removed, revealing the components of the label 5. The label 5 thus comprises a screen 8, a power source 9, a micro-controller 10, and a communication interface 11, all of which are affixed to the support 6.

According to the embodiment illustrated in FIGS. 1 through 8, the micro-controller 10 is linked to the power source 9, to the communication interface 11, and to the screen 8 by means of a connector 12.

The screen 8 is, for example, an e-paper screen, which makes it possible to obtain an electronic screen with an appearance similar to that of a standard sheet of paper, wherein ambient lighting, rather than backlighting as is the case in most screens, is used to render images.

Examples from the companies XEROX, PHILIPS, and E-INK were described in the introduction. E-paper generally comprises a substrate, such as a plastic film. Electronic ink (e-ink) is deposited on the substrate. This ink consists of polarized particles that react to currents, forming a semi-conductive substance. As examples of particles, mention may be made of organic molecules such as polymers, liquid crystals, or any other polarizable particle with optical properties. The ink can also comprise molecules emitting a radiation of which the wavelength varies relative to the excitation, such as those used for organic light-emitting diodes (OLEDs). The substrate has means for controlling the position of the particles or the excitation of the molecules. For example, the substrate is integrated with a printed circuit defining the screen pixels; hence by controlling the current in the circuit, it is possible to arrange the particles and thus define an image.

Depending on the technology employed, the image created can be polychromatic or monochromatic. The resolution of the images obtained on this type of screen is similar to that of standard screens. The images displayed can therefore be complex while maintaining a rendering that is pleasing to a customer.

Furthermore, certain inks display residual images, meaning that such inks do not need to be continuously supplied with current in order to display an image and only require power to induce a change of state (i.e., to change the image). When a current is applied to the circuit, the particles contained in these inks arrange themselves in order to display the image. When the current is cut off, the particles maintain their arrangement, thus preserving the displayed image. The particles will change their arrangement when a current is reapplied in order to display another image.

Hence the information about the product contained in the container 1 can be divided among a plurality of images that can be programmed to flash by at a predetermined rate; the amount of information displayed hence no longer being limited by the surface of the label 5.

The speed with which the particles are able to rearrange themselves and thus change the image can be sufficient to make the images flash by at the frame rate for a video (24 images per second). Hence it is possible to display actual videos, e.g., advertising videos, on the screen 8.

The screen 8 formed by the substrate, the means for controlling the ink particles, and the ink has an overall thickness of less than one millimeter and thus remains sufficiently flexible to conform to the support 6.

The power source 9 makes it possible to power the assembly of components of the label 5 in the form of, say, an electric current. In particular, it regulates the power supply for the screen 8 via the micro-controller 10. Preference is given to the source 9 being small in size so that it may be arranged inconspicuously on the support 6. For example, it can comprise photovoltaic cells that only operate in the presence of light or it can comprise batteries. The power source 9 can be associated with an energy storage component. During operation, the power source 9 can thus recharge the component on command by the micro-controller 10, enabling it to restore power at any time. This association can prove useful in the case of photovoltaic cells.

The storage component can be a storage cell, and in particular an electrochemical storage cell such as a supercapacitor, examples of which include the electrochemical double-layer capacitors developed by the company EPCOS (Electronique International, Electrochemical double-layer capacitors, Jean-Florent Helie, November 2004) or carbon nanotube-enhanced supercapacitors.

The micro-controller 10 comprises an integrated memory and defines the image to be displayed on the screen 8. According to the embodiment of the figures, the micro-controller 10 establishes the link between the screen 8 and the power source 9, thus regulating the distribution of power in the screen 8 for controlling the display. The micro-controller 10 inputs data for controlling the image to be displayed as well as the frame rate of the images. These data may relate specifically to the product contained in the container, such as its name, brand, price, expiration date, or contraindicated uses, but they may also relate to the product in a broader sense, for instance to possible by-products, recommendations for use in combination with other products, or they can even be in the form of actual commercials.

The data can be implemented decisively before the container 1 is displayed for sale. Alternatively, the data can also be updated once the container 1 is placed on the shelves.

In order to bring about such an updating, the communication interface 11 linked to the micro-controller 10 enables the receipt of data either remotely or via a cable for transmission to the micro-controller 10, which then updates the data already on file via the connector 12. The interface 11 also enables the transmission of data from the micro-controller 10 (data related to the shelf display time of the container 1, for example) to a remote receiver. The transmission and receiving system of the label 5 can be, for example, a radio or infrared system. In this case, the waves, either radio or infrared, may be used as a signature for uniquely identifying a container.

It is thus possible to remotely update the data displayed on the label 5 by sending new data. For example, when the price of containers 1 on the shelves of a store has to be changed in order to take the approach of the expiration date into account, the operation can be performed remotely. For example, an operator receives information about the containers 1 and determines for which ones the shelf time has exceeded a pre-specified threshold. He then configures a remote transmitter to send new data on the price of the containers 1 thus identified, and the price display on the screens 8 is then updated. It is therefore no longer necessary to make new labels with the new price and replace the obsolete labels one by one; hence a long, tedious, and expensive process is eliminated.

The way in which the label 8 can be affixed to the container 1 shall now be described.

According to a preferred embodiment, the label 5 is affixed by means of a film 20 such as a thermo-retractable film applied to the exterior side 3 of the body 2 of the container 1. Several configurations are conceivable. The thermo-retractable film 20 can consist of a single piece or two pieces and completely enclose the exterior side 3 on its perimeter or be in contact with only a part of this perimeter. The label 5 can likewise be affixed under or on the film 20.

In a first embodiment (FIGS. 3 through 5), the thermo-retractable film 20 is configured as a strip 21 of which the length is less than the perimeter of the body 2 of the container 1. In this case, two lateral end portions 22 of the support 6 of the label 5 are fastened under or on the end portions 23 of the strip 21 in such a way that the assembly 24 composed of the label 5 and the film 20 has the form of a sheath with a diameter greater than that of the container. In FIGS. 3 through 5, only the configuration in which the support 6 is fastened under the film 20 is shown. The label 5 is fastened under or on the thermo-retractable film 20 by gluing, welding, or by hot melting. The assembly 24 is then slid over the body 2 of the container 1. The container is then exposed to a heat source, under the effect of which the film 20 contracts against the container 1, pressing the label 5 against the body 2. Affixing the protective film 7 (in a manner not illustrated) over the components of the label 5—namely the screen 8, the power source 9, the microcontroller 10, and the communication interface 11—while leaving the screen 8 visible is conceivable in order to protect the label 5 from defacement due to impacts or soiling.

In a second embodiment (FIGS. 6 and 7), the thermo-retractable film 20 is configured as a complete sheath with a diameter greater than that of the container 1 and of the label 5. The support 6 of the label 5 is positioned against the middle region 4 of the container. The film is then slid over both the container 1 and the label 5. When the container 1 is placed in a kiln, the film 20 contracts against the container 1, taking the exact shape of the label 5 and fastening it to the container 1 under said thermo-retractable film 20. The thermo-retractable film 20 encloses the exterior side 3 on its entire perimeter and is transparent, at least in the vicinity of the screen 8 of the label 5, in order to leave the screen 8 visible.

According to another embodiment illustrated in FIGS. 8 and 9, the film 20 is configured as an open strip covering the label 5 in such a way that when said film is placed against the container 1, it contacts the exterior side 3 with its two end zones 25 on either side of the label 5, which end zones can be glued to the container 1 in order to affix the label 5.

The container 1 and the label 5 thus configured enable the creation of an eye-catching packaging for a customer by offering the possibility of displaying information in a plurality of images, the creation of animated images as in a video, and the updating of the information displayed in a simple manner that is both energy-efficient and cost-effective. The packaging becomes a new asset for the esthetic quality of the product, resulting in a greater capacity for displaying information.

The flexible support 6 and screen 8 render the label 5 adaptable to any shape of container.

The technique for affixing the label 5 by means of a thermo-retractable film 20 is also easy to employ and cost-effective, making it well suited to the pace of industrial production.

1. Container equipped with a body containing a product, on which is affixed a flexible electronic label adaptable to the contours of the container, the label comprising:
an electronic screen for displaying information relating to the product and visible to a user;
a micro-controller linked to the screen for controlling the display of information on said screen and the updating of said information;
a power source linked to the micro-controller;
wherein the label is affixed to the container by means of a film applied to an exterior side of the container.

2. Container as in claim 1, wherein the electronic screen is an electronic paper screen.

3. Container as in claim 2, wherein the electronic screen comprises a substrate on which is deposited a substance consisting of an electronic ink.

4. Container as in claim 3, wherein the electronic ink comprises an organic substance.

5. Container as in claim 3, wherein the electronic ink comprises liquid crystals.

6. Container as in claim 4, wherein the electronic ink comprises organic light-emitting diodes.

7. Container as in claim 1, which further comprises a communication interface linked to the micro-controller.

8. Container as in claim 7, wherein the interface transmits and receives radio waves.

9. Container as in claim 7, wherein the interface transmits and receives infrared waves.

10. Container as in claim 1, wherein the power source is a photovoltaic cell.

11. Container as in claim 1, wherein the power source is a battery.

12. Container as in claim 1, comprising an energy storage component.

13. Container as in claim 12, wherein the energy storage component is a storage cell.

14. Container as in claim 12, wherein the energy storage component is a supercapacitor.

15. Container as in claim 1, wherein the micro-controller regulates the power supplied to the screen.

16. Container as in claim 1, wherein the display on the electronic screen is a residual display.

17. Container as in claim 1, wherein the film is a thermo-retractable film.

18. Container as in claim 17, wherein the label is affixed on all or part of the thermo-retractable film.

19. Container as in claim 17, wherein the label is affixed under all or part of the thermo-retractable film, leaving the screen visible.

20. Container as in claim 1, wherein the label can be separated from the thermo-retractable film in order to facilitate recycling.
